(19) United States
(12) Patent Application Publication
(10) Pub. No.: US 2025/0229658 A1
(43) Pub. Date: Jul. 17, 2025

(54) TRANSFORMER FOR ON-BOARD CHARGER OF ELECTRIC VEHICLE

(71) Applicant: Atum Co., Ltd., Ansan-si (KR)

(72) Inventor: Taeksoo HAN, Seoul (KR)

(21) Appl. No.: 19/001,584

(22) Filed: Dec. 26, 2024

(30) Foreign Application Priority Data
Jan. 11, 2024 (KR) 10-2024-0005077

(51) Int. Cl. B60L 53/22; H01F 27/28; H01F 27/30; H01F 30/06

(52) U.S. Cl. CPC B60L 53/22; H01F 27/2823; H01F 27/306; H01F 30/06; B60L 2210/22

(57) ABSTRACT

Provided relates to a transformer for an on-board charger of an electric vehicle, including a primary coil receiving power from the charger of the electric vehicle; and a secondary coil outputting induced current to the high-voltage battery, wherein the primary coil is formed by winding a first adhesive-coated rectangular wire in a coil shape, and the secondary coil is formed by winding the second adhesive-coated rectangular wire in a coil shape. The first and second adhesive-coated rectangular wires include: copper stranded wires formed by twisting multiple strands of copper wires and arranged to be in contact with each other; copper stranded wire rectangular bundles formed to have a rectangular shape of the arrangement of the copper stranded wires; insulating envelopes applied along the outer surface of the copper stranded wire rectangular bundles; and bonding layers formed by applying adhesive on the outer surface of the insulating envelopes.

### BACKGROUND OF THE INVENTION

### Field of the Invention

The present invention relates to an on-board charger for an electric vehicle.

### Background Art

Plug-in hybrid electric vehicles (PHEVs) and electric vehicles (EVs) (hereinafter, collectively referred to as electric vehicles) require a charging device capable of charging a high-voltage battery which drives a vehicle motor at 200V AC, and such a device is known as an on-board charger (OBC).

The electric vehicle includes: an on-board charger (OBC) for charging a high-voltage battery which drives a vehicle motor at 200V AC; a high-voltage battery charging the converted power from the on-board charger (OBC); and a low DC-DC converter (LDC) converting the high voltage of the high-voltage battery into a 12V low voltage to supply power to electronic components of the vehicle.

The on-board charger (OBC) integrated into the electric vehicle includes: a first converter which full-wave rectifies the 220V AC supplied from the charger through a bridge diode and boosts the rectified voltage through a boost converter circuit; a second converter which converts the rectified voltage output from the first converter into a high-frequency AC voltage through a full-bridge circuit; a transformer which transforms the high-frequency AC voltage output from the second converter to a higher voltage and physically isolates the 220 V AC and the high-voltage battery; and a rectifier unit which rectifies and filters the high-frequency high-voltage AC voltage transformed by the transformer, converts the rectified AC voltage into DC voltage, and supplies the DC voltage to the high-voltage battery.

Here, the configuration of the transformer for the on-board charger (OBC) according to the conventional art will be described.

The transformer for the on-board charger (OBC) according to the conventional art includes a specially manufactured bobbin, a primary coil wound on the bobbin, and insulation tape wrapping around the primary coil to insulate the primary coil.

A secondary coil is wound on the insulation tape wrapping around the primary coil. After the secondary coil is wound, the insulation tape is wrapped around the secondary coil to insulate the secondary coil. In a case where the secondary coil is wound three times (e.g., three layers), whenever the secondary coil is wound, the insulation tape is applied after each layer to ensure insulation.

However, the transformer for the on-board charger (OBC) according to the conventional art has the following problems.
First, the size of the transformer is significantly large. That is, the transformer for the on-board charger (OBC) according to the conventional art has the problem that the size of the transformer is increased because the secondary coil is wound coaxially over the primary coil, thus increasing the overall size of the on-board charger (OBC).
Second, the transformer for the on-board charger (OBC) according to the conventional art is deteriorated in productivity due to an increase of assembly processes since the assembly processes of winding the primary coil, wrapping the insulation tape on the primary coil for insulation, winding the secondary coil on the insulation tape, and wrapping the insulation tape on the secondary coil are repeated.
Third, the transformer for the on-board charger (OBC) according to the conventional art has the problem that EMI performance is deteriorated due to an increase of losses since manual winding of the primary and secondary coils often results in misalignment.

### SUMMARY OF THE INVENTION

Accordingly, the present invention has been made to solve the above-mentioned problems occurring in the prior arts, and a transformer for an on-board charger of an electric vehicle according to the present invention has the following objectives.
First, first and second adhesive-coated rectangular wires are closely wound face-to-face by shaping copper stranded wires of primary and secondary coils into a rectangular form, covering the outer surfaces thereof with insulating envelopes, and forming bonding layers thereon, and are bonded through fusion bonding to form a coil shape, resulting in excellent face-to-face adhesion and better space utilization for the same number of windings compared to conventional wires.
Second, the transformer for the on-board charger of the electric vehicle can minimize the space occupied on a main printed circuit board of the OBC by reducing the volume of the transformer for the OBC.
Third, the transformer for the on-board charger of the electric vehicle provides excellent face-to-face adhesion and superior space utilization compared to conventional wires, thus minimizing the value of leakage current.
Fourth, the transformer for the on-board charger of the electric vehicle does not cause insulation breakdown even at high voltages in the range of several to tens of kV, and can maintain the efficiency between the primary coil and the secondary coil.
Fifth, the transformer for the on-board charger of the electric vehicle can supply high current and high voltage in a compact size.
Sixth, a pair of support tubes are formed vertically around a second disk to simultaneously hold first and second magnetic cores and primary and secondary coils, and first and third mounts hold the first and second magnetic cores, thus allowing the entire bundle of the transformer to be stably assembled with the small number of components without movement or displacement.
Seventh, since the rear surface of a boss, the rear surface of a first rear wing, and the rear surface of a third rear wing, which are located at the rearmost side of the transformer protruding rearward, are all positioned on the same vertical plane and all have flat surfaces and configured as flat planes, facilitating mounting of the transformer for the on-board charger of the electric vehicle according to an embodiment of the present invention onto a rear fixture.

To accomplish the above object, according to the present invention, there is provided a transformer for an on-board charger of an electric vehicle, which charges a high-voltage battery of the electric vehicle with commercial AC power supplied from a charger, including: a flat-type primary coil which receives power from the charger of the electric vehicle; and a flat-type secondary coil which generates induced current by the current flowing through the primary coil and outputs the induced current to the high-voltage battery. The primary coil is formed by winding a first adhesive-coated rectangular wire in a coil shape so that a first hollow part is formed at the center, wherein the first adhesive-coated rectangular wire includes: copper stranded wires formed by twisting multiple strands of copper wires and arranged to be in contact with each other; a copper stranded wire rectangular bundle formed to have a rectangular shape of the arrangement of the copper stranded wires; an insulating envelope applied along the outer surface of the copper stranded wire rectangular bundle; and a bonding layer formed by applying adhesive on the outer surface of the insulating envelope. The primary coil is formed by winding the first adhesive-coated rectangular wire multiple times with a winding member so that they are in close contact with each other face-to-face, melting and hardening the bonding layer, such that the first adhesive-coated rectangular wires closely wound are bonded in a coil shape by fusion bonding. The secondary coil is formed by winding the second adhesive-coated rectangular wire in a coil shape so that the second hollow part is formed at the center, wherein the second adhesive-coated rectangular wire includes: copper stranded wires formed by twisting multiple strands of copper wires and arranged to be in contact with each other; a copper stranded wire rectangular bundle formed to have a rectangular shape of the arrangement of the copper stranded wires; an insulating envelope applied along the outer surface of the copper stranded wire rectangular bundle; and a bonding layer formed by applying adhesive on the outer surface of the insulating envelope. The secondary coil is formed by winding the second adhesive-coated rectangular wire multiple times with a winding member so that they are in close contact with each other face-to-face, melting and hardening the bonding layer, such that the second adhesive-coated rectangular wires closely wound face-to-face are bonded in a coil shape by fusion bonding.

The transformer for an on-board charger of an electric vehicle, as described in the present invention with the above configuration, has the following effects.
First, the first and second adhesive-coated rectangular wires are closely wound face-to-face by shaping the copper stranded wires of the primary and secondary coils into a rectangular form, covering the outer surfaces thereof with the insulating envelopes, and forming the bonding layers thereon, and are bonded through fusion bonding to form a coil shape, resulting in excellent face-to-face adhesion and better space utilization for the same number of windings compared to conventional wires.
Second, the transformer for the on-board charger of the electric vehicle can minimize the space occupied on a main printed circuit board of the OBC by reducing the volume of the transformer for the OBC.
Third, the transformer for the on-board charger of the electric vehicle provides excellent face-to-face adhesion and superior space utilization compared to conventional wires, thus minimizing the value of leakage current.
Fourth, the transformer for the on-board charger of the electric vehicle does not cause insulation breakdown even at high voltages in the range of several to tens of kV, and can maintain the efficiency between the primary coil and the secondary coil.
Fifth, the transformer for the on-board charger of the electric vehicle can supply high current and high voltage in a compact size.
Sixth, a pair of support tubes are formed vertically around the second disk to simultaneously hold the first and second magnetic cores and the primary and secondary coils, and the first and third mounts hold the first and second magnetic cores, thus allowing the entire bundle of the transformer to be stably assembled with the small number of components without movement or displacement.
Seventh, since the rear surface of a boss, the rear surface of a first rear wing, and the rear surface of a third rear wing, which are located at the rearmost side of the transformer protruding rearward, are all positioned on the same vertical plane and all have flat surfaces and configured as flat planes, facilitating mounting of the transformer for the on-board charger of the electric vehicle according to an embodiment of the present invention onto a rear fixture.

### BRIEF DESCRIPTION OF THE DRAWINGS

FIG. 1 is a perspective view of a transformer for an on-board charger of an electric vehicle according to an embodiment of the present invention.

FIG. 2 is an exploded perspective view of the transformer for the on-board charger of the electric vehicle according to an embodiment of the present invention.

FIG. 3 is a bottom perspective view of FIG. 2.

FIG. 4 is a cross-sectional view in the front-rear direction of FIG. 1.

FIG. 5 is a cross-sectional view in the front-rear direction of the transformer for the on-board charger of the electric vehicle according to an embodiment of the present invention, from which first and second magnetic cores 160 and 170 are removed.

FIG. 6 is a perspective view of the transformer for the on-board charger of the electric vehicle according to an embodiment of the present invention, from which the first and second magnetic cores 160 and 170 are removed.

FIGS. 7A to 7D are conceptual diagrams illustrating first and second adhesive-coated rectangular wires 110′ and 120′ forming primary and secondary coils 110 and 120 in a transformer for an on-board charger of an electric vehicle according to another embodiment of the present invention,

wherein FIG. 7A is a conceptual diagram of the first and second adhesive-coated rectangular wires 110′ and 120′ in a state where insulating envelopes 112 and 122 are fully covered,

FIG. 7B is a conceptual diagram of the first and second adhesive-coated rectangular wires 110′ and 120′ in a state where the insulating envelopes 112 and 122 are partially exposed,

FIG. 7C is a conceptual diagram of the first and second adhesive-coated rectangular wires 110′ and 120′ for explaining bonding layers 113 and 123, and

FIG. 7D is a conceptual diagram of copper stranded wires 111 and 121 of the primary and secondary coils, which are formed by twisting multiple strands of copper wires Li.

### DETAILED DESCRIPTION OF THE PREFERRED EMBODIMENT

Hereinafter, preferred embodiments of a transformer for an on-board charger of an electric vehicle of the present invention will be described in detail with reference to the attached drawings.

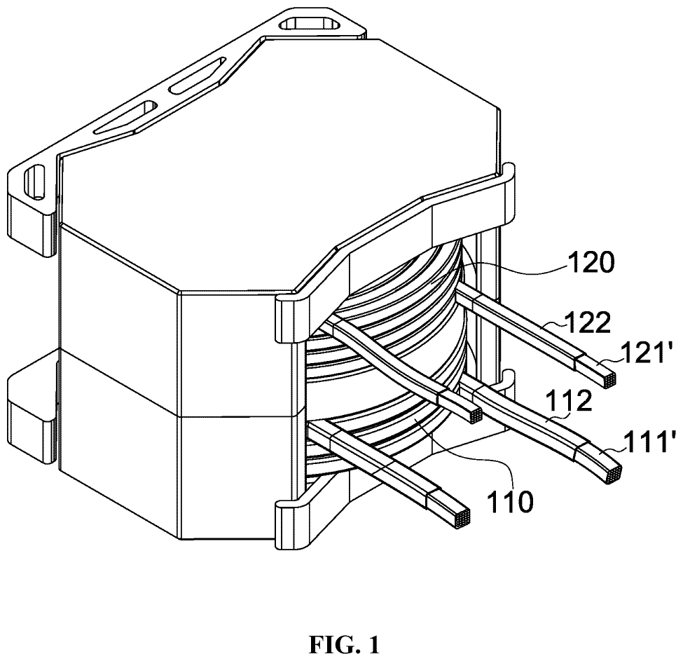

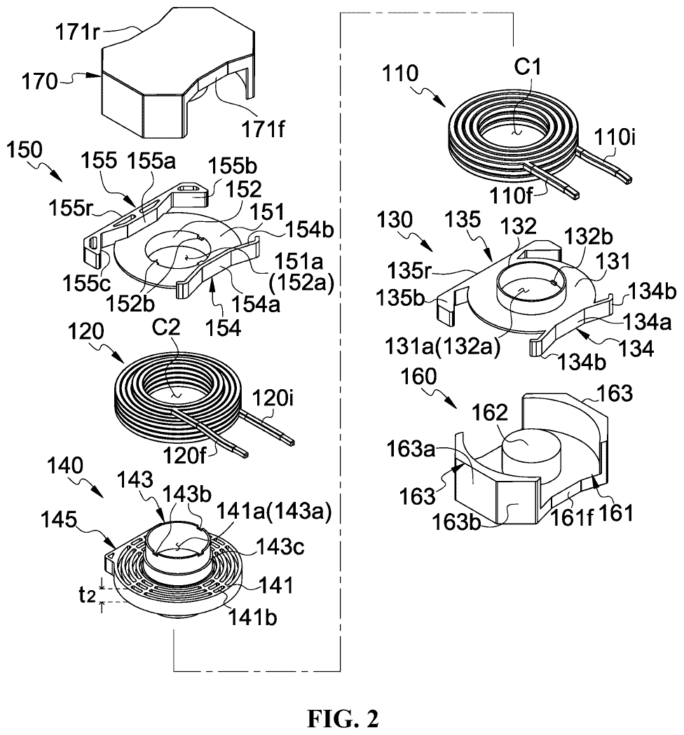

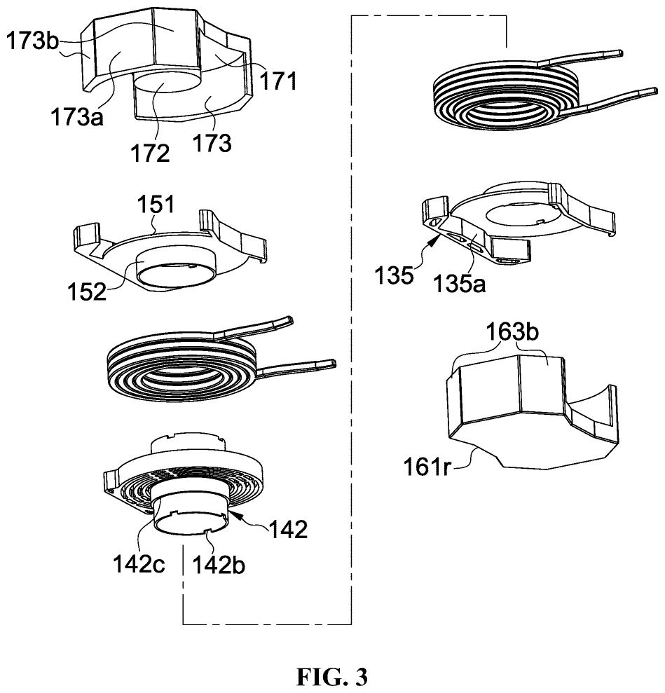

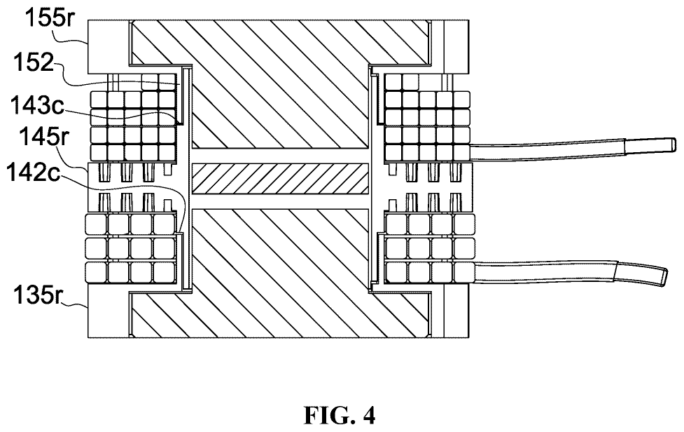

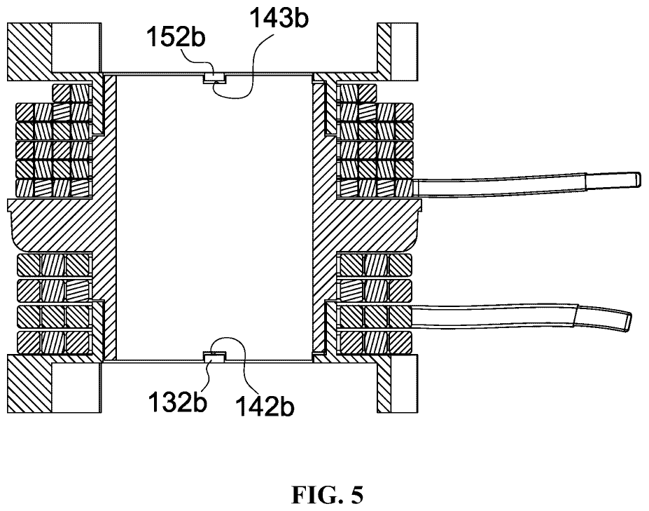

In FIGS. 1 to 6, primary and secondary coils 110 and 120 formed of first and second adhesive-coated rectangular wires 110′ and 120′ are not illustrated in detail but are conceptually represented.

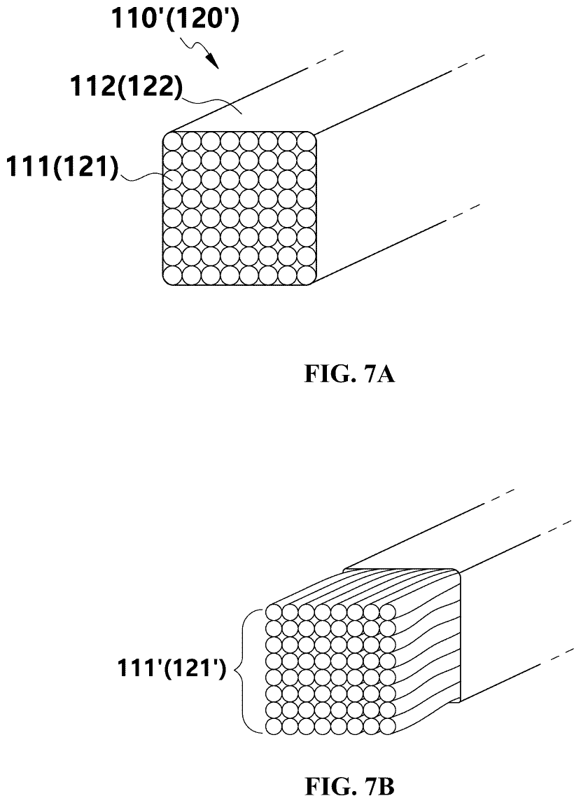

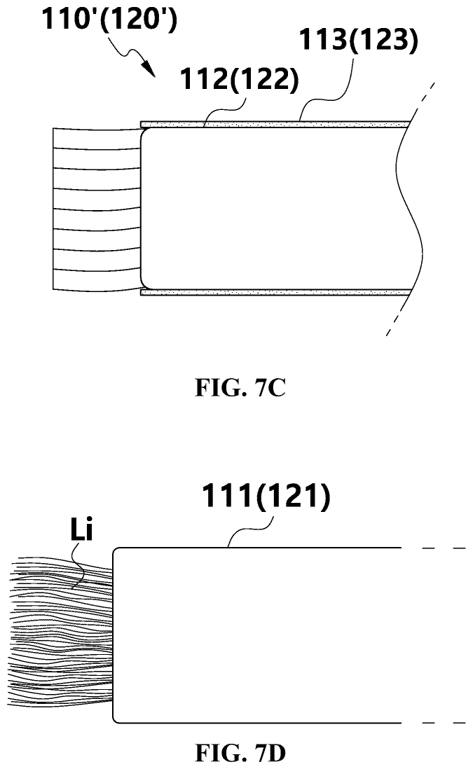

The detailed structure of the first and second adhesive-coated rectangular wires 110′ and 120′ forming the primary and secondary coils 110 and 120 disclosed in FIGS. 1 through 6 is illustrated in FIGS. 7A-7D.

The transformer for the on-board charger of the electric vehicle, which charges a high-voltage battery (not shown) of the electric vehicle with commercial AC power 220V AC supplied from a charger (not shown), includes: a flat-type primary coil 110 which receives power from the charger of the electric vehicle; and a flat-type secondary coil 120 which generates induced current by the current flowing through the primary coil 110 and outputs the induced current to the high-voltage battery.

Here, the primary coil 110 is formed by winding a first adhesive-coated rectangular wire 110′ in a coil shape so that a first hollow part C1 is formed at the center.

The first adhesive-coated rectangular wire 110′ includes: copper stranded wires 111 formed by twisting multiple strands of copper wires Li and arranged to be in contact with each other; a copper stranded wire rectangular bundle 111′ formed to have a rectangular shape of the arrangement of the copper stranded wires 111; an insulating envelope 112 applied along the outer surface of the copper stranded wire rectangular bundle 111′; and a bonding layer 113 formed by applying adhesive on the outer surface of the insulating envelope 112.

At this instance, the primary coil 110 is formed by winding the first adhesive-coated rectangular wire 110′ multiple times with a winding member (not shown) so that they are in close contact with each other face-to-face, melting and hardening the bonding layer 113, for example, using a solvent (e.g., alcohol) or by applying heat (or hot air), such that the first adhesive-coated rectangular wires 110′ closely wound are bonded in a coil shape by fusion bonding.

Moreover, the secondary coil 120 is formed by winding the second adhesive-coated rectangular wire 120′ in a coil shape so that the second hollow part C2 is formed at the center.

The second adhesive-coated rectangular wire 120′ includes: copper stranded wires 121 formed by twisting multiple strands of copper wires Li and arranged to be in contact with each other; a copper stranded wire rectangular bundle 121′ formed to have a rectangular shape of the arrangement of the copper stranded wires 121; an insulating envelope 122 applied along the outer surface of the copper stranded wire rectangular bundle 121′; and a bonding layer 123 formed by applying adhesive on the outer surface of the insulating envelope 122.

Here, the secondary coil 120 is formed by winding the second adhesive-coated rectangular wire 120′ multiple times with a winding member (not shown) so that they are in close contact with each other face-to-face, melting and hardening the bonding layer 123, for example, using a solvent (e.g., alcohol) or by applying heat (or hot air), such that the second adhesive-coated rectangular wires 120′ closely wound face-to-face are bonded in a coil shape by fusion bonding.

As described above, the first and second adhesive-coated rectangular wires 110′ and 120′ are closely wound face-to-face by shaping the copper stranded wires 111 and 121 of the primary and secondary coils 110 and 120 into a rectangular form, covering the outer surfaces thereof with insulating envelopes 112 and 122, and forming bonding layers 113 and 123 thereon, and are bonded through fusion bonding to form a coil shape, resulting in excellent face-to-face adhesion and better space utilization for the same number of windings compared to conventional wires, thereby reducing the volume of the transformer for the OBC and minimizing the space occupied on a main printed circuit board (PCB) (not shown) of the OBC.

Furthermore, the transformer for the on-board charger of the electric vehicle provides excellent face-to-face adhesion and superior space utilization compared to conventional wires, thus minimizing the value of leakage current.

Additionally, the transformer for the on-board charger of the electric vehicle does not cause insulation breakdown even at high voltages in the range of several to tens of kV, and can maintain the efficiency between the primary coil 110 and the secondary coil 120.

Moreover, the transformer for the on-board charger of the electric vehicle, due to the specific structure of the primary coil 110 and the secondary coil 120 as described above, can supply high current and high voltage in a compact size.

In addition, since the primary coil 110 and the secondary coil 120 of the transformer for the OBC are formed by fusion bonding, the adhesion of the primary coil 110 and the secondary coil 120 themselves is increased and the adhesion between the primary coil 110 and the secondary coil 120 is also increased, thereby reducing losses, improving efficiency even further, significantly reducing the height of the transformer (up to 70 percent smaller compared to conventional OBC transformers), and minimizing the size of the transformer (up to 70 percent smaller compared to conventional OBC transformers).

Moreover, as the height of the transformer for the OBC decreases and the size of the transformer becomes smaller, the overall size of the OBC can be reduced, so the occupied space inside the electric vehicle is reduced and the weight of the electric vehicle is also reduced, thus enhancing the competitiveness of the OBC product in electric vehicles.

Additionally, as described above, since the primary coil 110 and the secondary coil 120 of the transformer for the OBC can be manufactured using winding jigs or winding machines, the production of the primary coil 110 and the secondary coil 120 of the transformer for the OBC can be automated, significantly reducing assembly processes (50 percent reduction in assembly processes compared to the conventional OBC transformer production process), thereby greatly improving productivity and enhancing price competitiveness.

The winding member may be a winding jig or a winding machine.

The adhesive may be adhesive paint.

The copper stranded wire rectangular bundle 111′ forming the first adhesive-coated rectangular wire 110′ is formed in a rectangular shape by closely arranging the copper stranded wires 111 in vertical and horizontal directions.

Similarly, the copper stranded wire rectangular bundle 121′ forming the second adhesive-coated rectangular wire 120′ is formed in a rectangular shape by closely arranging the copper stranded wires 121 in vertical and horizontal directions.

At this point, as illustrated in the illustrated drawings, the rectangular shape of the copper stranded wire rectangular bundle 111′ and 121′ can be a square, or a rectangle depending on embodiments.

The rectangular shape of the copper stranded wire rectangular bundle 111′ and 121′ of the first and second adhesive-coated rectangular wires 110′ and 120′ can be formed by passing through a quadrilateral roller designed to form the rectangular shape.

An input part 110i and an output part 110f of the primary coil 110 are connected to the charger side of the electric vehicle, and an input part 120i and an output part 120f of the secondary coil 120 are connected to the charger side of the electric vehicle.

The input part 110i and the output part 110f of the primary coil 110 are all wound such that they are arranged in the same direction, toward the electric vehicle charger. Similarly, the input part 120i and the output part 120f of the secondary coil 120 are wound such that they are arranged in the same direction.

As described above, the primary coil 110 and the secondary coil 120 of the transformer for the OBC are all formed as flat coils and are inserted into a single housing, thus reducing the height of the OBC transformer product, and minimizing the size of the product.

Additionally, losses between the primary and secondary coils of the OBC in the electric vehicle can be reduced, thereby improving efficiency.

The insulating envelopes 112 and 122 are made of insulating tape.

The insulating tape may be, for example, Kapton tape.

The transformer for the on-board charger of the electric vehicle according to an embodiment of the present invention includes: a first magnetic core 160 inserted into the first hollow part C1 of the primary coil 110; a second magnetic core 170 inserted into the second hollow part C2 of the secondary coil 120 from above the first magnetic core 160 to form a closed magnetic flux with the first magnetic core 160; a first mount 130 inserted into the first magnetic core 160 to hold the primary coil 110; a second mount 140 inserted and fixed into primary coil 110 fixed on the first mount 130 and insulating while maintaining an insulation distance between the primary coil 110 and the secondary coil 120; and a third mount 150 inserted and fixed into the secondary coil 120 inserted and fixed into the second mount 140.

The first magnetic core 160 includes: a flat base part 161; a center leg 162 protruding from the center of the base part 161 toward the primary coil 110 and inserted into the first hollow part C1 of the primary coil 110; and a pair of outer legs 163 protruding from the outer side of the base part 161 toward the primary coil 110 and spaced apart from the center leg 162.

The second magnetic core 170 includes: a flat base part 171; a center leg 172 protruding from the center of the base part 171 toward the secondary coil 120 and inserted into the second hollow part C2 of the secondary coil 120; and a pair of outer legs 173 protruding from the outer side of the base part 171 toward the secondary coil 120 and spaced apart from the center leg 172.

The first mount 130 includes: a thin plate-shaped first plate 131 having a first central hole 131a formed at the center thereof; a cylindrical first support tube 132 having a first through hole 132a formed to communicate with the first central hole 131a of the first plate 131 to be inserted into the first hollow part C1 of the primary coil 110, and holding the primary coil 110 by protruding from the first central hole 131a toward the primary coil 110; a first front wing 134 protruding from the front edge of the first plate 131 toward the first magnetic core 160, and being in close contact with the front surface 161f and the outer legs of the first base part 161 of the first magnetic core 160 to prevent movement or displacement of the first mount 130; and a first rear wing 135 protruding from the rear edge of the first plate 131 toward the first magnetic core 160, and being in close contact with the rear surface 161r and the outer legs 163 of the first base part 161 to prevent movement or displacement of the first mount 130.

The second mount 140 includes: a circular plate-shaped second disk 141 having a second central hole 141a; a cylindrical second lower support tube 142 having a second lower through hole 142a formed to communicate with the second central hole 141a of the second disk 141 to be inserted into the first hollow part C1 of the primary coil 110, and protruding from the second central hole 141a toward the primary coil 110 to be partially mounted with the first support tube 132 of the first mount 130 {namely, the first support tube 132 and the second lower support tube 142 partially overlap or cross in the height direction (axial direction)} and hold the upper side of the primary coil 110; and a cylindrical second upper support tube 143 having a second upper through hole 143a formed to communicate with the second central hole 141a of the second disk 141 to be inserted into the second hollow part C2 of the secondary coil 120, and protruding from the second central hole 141a toward the secondary coil 120 to be partially mounted with a third support tube 152 of the third mount 150 {namely, the third support tube 152 and the second upper support tube 143 partially overlap or cross in the height direction (axial direction)} and hold the lower side of the secondary coil 120.

Furthermore, the third mount 150 includes: a thin plate-shaped third plate 151 having a third central hole 151a; a cylindrical third support tube 152 having a third through hole 152a formed to communicate with the third central hole 151a of the third plate 151 to be inserted into the second hollow part C2 of the secondary coil 120, and protruding from the third central hole 151a toward the secondary coil 120 to be partially mounted with the second upper support tube 143 of the second mount 140 {namely, the third support tube 152 and the second upper support tube 143 partially overlap or cross in the height direction (axial direction)} and hold the upper side of the secondary coil 120; a third front wing 154 protruding from the front edge of the third plate 151 toward the second magnetic core 170, and being in close contact with a front surface 171f of the second base part 171 of the second magnetic core 170 at the same time to prevent movement or displacement of the third mount 150; and a third rear wing 155 protruding from the rear edge of the third plate 151 toward the second magnetic core 170, and being in close contact with a rear surface 171r and the outer legs 173 of the second base part 171 of the second magnetic core 170 to prevent movement or displacement of the third mount 150.

The primary coil 110 is mounted on the first plate 131 and inserted between the first plate 131 and the second disk 141 in the height direction, and externally fits and fixes the first hollow part C1 to the first support tube 132 and the second lower support tube 142 in the radial direction.

The secondary coil 120 is mounted on the second disk 141 and inserted between the second disk 141 and the third plate 151 in the height direction, and externally fits and fixes the second hollow part C2 to the third support tube 152 and the second upper support tube 143 in the radial direction.

The first magnetic core 160 is located below the first mount 130 (i.e., in the opposite direction of the primary coil 110), and is inserted into the first hollow part C1 of the primary coil 110 by being inserted into the first support tube 132 and the second lower support tube 142 in which the center leg 162 is axially mounted.

The second magnetic core 170 is located above the second mount 140 (i.e., in the opposite direction of the secondary coil 120), and is inserted into the second hollow part C2 of the secondary coil 120 by being inserted into the third support tube 152 and the second upper support tube 143 in which the center leg 172 is axially mounted.

As described above, a pair of support tubes 142 and 143 are formed vertically around the second disk 141 to simultaneously hold the first and second magnetic cores 160 and 170 and the primary and secondary coils 110 and 120, and the first and third mounts 130 and 150 hold the first and second magnetic cores 160 and 170, thus allowing the entire bundle of the transformer to be stably assembled with the small number of components without movement or displacement.

The first plate 131 of the first mount 130 has a circular plate shape that matches the primary coil 110, the third plate 151 of the third mount 150 has a circular plate shape that matches the secondary coil 120, and the second disk 141 of the second mount 140 has a circular disk shape that matches the primary and secondary coils 110 and 120.

The first front wing 134 of the first mount 130 includes: a first front wing central part 134a protruding from the front edge of the first plate 131 toward the first magnetic core 160 to be in close contact with the center of the front surface 161f of the base part 161 of the first magnetic core 160; and a first front wing bent part 134b extending from the first front wing central part 134a to be bilaterally symmetrical and being in close contact with the outer edges of the front surface 161f of the base part 161 and the outer legs 163 of the first magnetic core 160.

Similarly, the first rear wing 135 of the first mount 130 includes: a first rear wing central part 135a protruding from the rear edge of the first plate 131 toward the first magnetic core 160 to be in close contact with the center of the rear surface 161r of the base part 161 of the first magnetic core 160; and a first rear wing bent part 135b extending from the first rear wing central part 135a to be bilaterally symmetrical and being in close contact with the outer edges of the rear surface 161r of the base part 161 and the outer legs 163 of the first magnetic core 160.

The outer surface of the outer leg 163 of the first magnetic core 160 includes: a horizontal plane 163a formed at the center thereof; and a pair of inclined planes 163b symmetrically sloping inward toward the center leg 162 from the horizontal central plane 163a.

The first front wing bent part 134b is concavely bent inward to be in close contact with the front surface 161f of the base part 161 and the inclined planes 163b of the outer legs 163 of the first magnetic core 160 at the same time.

Similarly, the first rear wing bent part 135b is concavely bent inward to be in close contact with the rear surface 161r of the base part 161 and the inclined planes 163b of the outer legs 163 of the first magnetic core 160 at the same time.

The third front wing 154 of the third mount 150 includes: a third front wing central part 154a protruding from the front edge of the third plate 151 toward the second magnetic core 170 to be in close contact with the center of the front surface 171f of the base part 171 of the second magnetic core 170; and a third front wing bent part 154b extending from the third front wing central part 154a to be bilaterally symmetrical and being in close contact with the outer edges of the front surface 171f of the base part 161 and the outer legs 173 of the second magnetic core 170.

Similarly, the third rear wing 155 of the third mount 150 includes: a third rear wing central part 155a protruding from the rear edge of the third plate 151 toward the second magnetic core 170 to be in close contact with the center of the rear surface 171r of the base part 171 of the second magnetic core 170; and a third rear wing bent part 155b extending from the second rear wing central part 155a to be bilaterally symmetrical and being in close contact with the outer edges of the rear surface 171r of the base part 171 and the outer legs 173 of the second magnetic core 170.

The outer surface of the outer leg 173 of the second magnetic core 170 includes: a horizontal plane 173a formed at the center thereof; and a pair of inclined planes 173b symmetrically sloping inward toward the center leg 172 from the horizontal central plane 173a.

The third front wing bent part 154b is concavely bent inward to be in close contact with the front surface 171f of the base part 171 and the inclined planes 173b of the outer legs 173 of the second magnetic core 170 at the same time, and the third rear wing bent part 175b is concavely bent inward to be in close contact with the rear surface 171r of the base part 171 and the inclined planes 173b of the outer legs 173 of the second magnetic core 170 at the same time.

A lower step flange 142c is formed on the outer peripheral surface of the second lower support tube 142, and an upper step flange 143c is formed on the outer peripheral surface of the second upper support tube 143.

The lower step flange 142c of the second lower support tube 142 is step-supported on the top of the first support tube 132, allowing the first support tube 132 and the second lower support tube 142 to overlap axially. In the state where the first support tube 132 and the second lower support tube 142 overlap axially, the outer peripheral surfaces of the first support tube 132 and the second lower support tube 142 form the same surface.

The bottom of the third support tube 152 is step-supported on the upper step flange 143c of the second upper support tube 143, allowing the second upper support tube 143 and the third support tube 152 to overlap axially. In the state where the second upper support tube 143 and the third support tube 152 overlap axially, the outer peripheral surfaces of the second upper support tube 143 and the third support tube 152 form the same surface.

Additionally, second lower fitting grooves 142b are formed on the outer circumference of the second lower support tube 142 at regular intervals, and first fitting protrusions 132b which fit into the second lower fitting grooves 142b are formed on the inner circumference of the first support tube 132 of the first mount 130.

In addition, second upper fitting grooves 143b are formed on the outer circumference of the second upper support tube 143 at regular intervals, and third fitting protrusions 152b which fit into the second upper fitting grooves 143b are formed on the inner circumference of the third support tube 152 of the third mount 150.

The organic coupling relationship of ‘the magnetic cores 160 and 170->the first and third mounts 130 and 150->the second mount 140’ can generally prevent movement or displacement and ensure stable fastening.

In the transformer for the on-board charger of the electric vehicle according to an embodiment of the present invention, a boss 145 protrudes rearward from the rear surface of the second disk 141 and has a rear surface 145r of a flat plane.

The rear surface 135r of the first rear wing 135 is a flat plane, the rear surface 155r of the third rear wing 155 is a flat plane, and the rear surface 145r of the boss 145, the rear surface 135r of the first rear wing, and the rear surface 155r of the third rear wing are all positioned on the same vertical plane.

Since the rear surface 145r of the boss 145, the rear surface 135r of the first rear wing, and the rear surface 155r of the third rear wing, which are located at the rearmost side of the transformer protruding rearward, are all positioned on the same vertical plane and all have flat surfaces and configured as flat planes, facilitating mounting the transformer for the on-board charger of the electric vehicle according to an embodiment of the present invention onto a rear fixture.

The second disk 141 includes a plurality of heat dissipation holes 141b formed to penetrate vertically, thereby rapidly dissipating heat generated by the transformer.

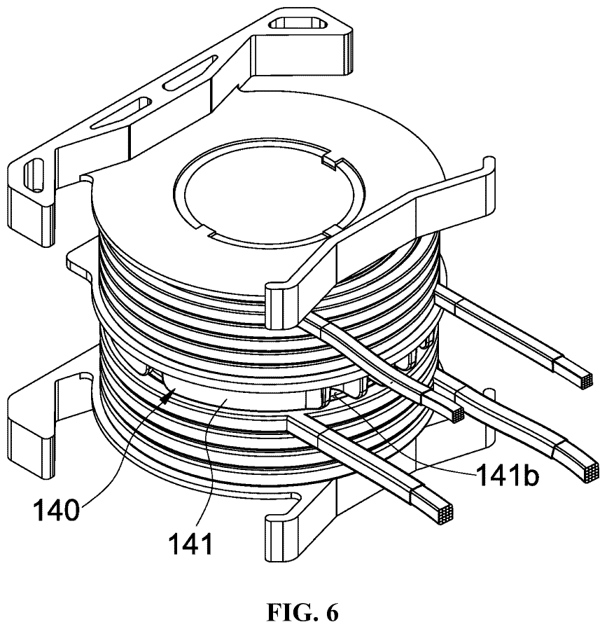

As illustrated in FIG. 6, in the transformer for the on-board charger of the electric vehicle according to another embodiment of the present invention, an opening 141b, which is radially inward and is opened outwardly is formed on the outer peripheral surface of the second disk 141.

The opening 141b formed on the second disk 141 can improve heat dissipation efficiency and facilitate the internal injection of heat-dissipating resin for external heat dissipation.

The transformer for the on-board charger of the electric vehicle according to another embodiment of the present invention can adjust the insulation distance between the primary coil 110 and the secondary coil 120 by controlling the thickness t2 of the second disk 141.

In addition, to maintain the insulation distance, it is preferable for the thickness t2 of the second disk 141 to be greater than the thickness of the first and third plates.

More preferably, the thickness t2 of the second disk 141 should be three or five times thicker than that of the first and third plates.

As described above, while the present invention has been particularly shown and described with reference to the example embodiments thereof, it will be understood by those of ordinary skill in the art that the present invention can be implemented as other concrete forms without changing the inventive concept or essential features. Therefore, these embodiments as described above are only proposed for illustrative purposes and do not limit the present invention.

It will be apparent to those skilled in the art that a variety of modifications and variations may be made without departing the spirit and scope of the present invention as defined by the appended claims. Further, such modifications and variations should not be understood independently from the technical idea or perspective of the present invention.

What is claimed is:

1. A transformer for an on-board charger of an electric vehicle, which charges a high-voltage battery of the electric vehicle with commercial AC power supplied from a charger, comprising:
a flat-type primary coil which receives power from the charger of the electric vehicle; and
a flat-type secondary coil which generates induced current by the current flowing through the primary coil and outputs the induced current to the high-voltage battery,
wherein the primary coil is formed by winding a first adhesive-coated rectangular wire in a coil shape so that a first hollow part is formed at the center,
wherein the first adhesive-coated rectangular wire includes:
copper stranded wires formed by twisting multiple strands of copper wires and arranged to be in contact with each other;
a copper stranded wire rectangular bundle formed to have a rectangular shape of the arrangement of the copper stranded wires;
an insulating envelope applied along the outer surface of the copper stranded wire rectangular bundle; and
a bonding layer formed by applying adhesive on the outer surface of the insulating envelope,
wherein the primary coil is formed by winding the first adhesive-coated rectangular wire multiple times with a winding member so that they are in close contact with each other face-to-face, melting and hardening the bonding layer, such that the first adhesive-coated rectangular wires closely wound are bonded in a coil shape by fusion bonding,
wherein the secondary coil is formed by winding the second adhesive-coated rectangular wire in a coil shape so that the second hollow part is formed at the center,
wherein the second adhesive-coated rectangular wire includes:
copper stranded wires formed by twisting multiple strands of copper wires and arranged to be in contact with each other;
a copper stranded wire rectangular bundle formed to have a rectangular shape of the arrangement of the copper stranded wires;
an insulating envelope applied along the outer surface of the copper stranded wire rectangular bundle; and
a bonding layer formed by applying adhesive on the outer surface of the insulating envelope, and
wherein the secondary coil is formed by winding the second adhesive-coated rectangular wire multiple times with a winding member so that they are in close contact with each other face-to-face, melting and hardening the bonding layer, such that the second adhesive-coated rectangular wires closely wound face-to-face are bonded in a coil shape by fusion bonding.

2. The transformer for an on-board charger of an electric vehicle according to claim 1, wherein the copper stranded wire rectangular bundle forming the first adhesive-coated rectangular wire is formed in a rectangular shape by closely arranging the copper stranded wires in vertical and horizontal directions, and
wherein the copper stranded wire rectangular bundle forming the second adhesive-coated rectangular wire is formed in a rectangular shape by closely arranging the copper stranded wires in vertical and horizontal directions.

3. The transformer for an on-board charger of an electric vehicle according to claim 1, further comprising:
a first magnetic core inserted into the first hollow part of the primary coil;
a second magnetic core inserted into the second hollow part of the secondary coil from above the first magnetic core to form a closed magnetic flux with the first magnetic core;
a first mount inserted into the first magnetic core to hold the primary coil;
a second mount inserted and fixed into primary coil fixed on the first mount and insulating while maintaining an insulation distance between the primary coil and the secondary coil; and
a third mount inserted and fixed into the secondary coil inserted and fixed into the second mount.

4. The transformer for an on-board charger of an electric vehicle according to claim 3, wherein the first magnetic core includes:
a flat base part;
a center leg protruding from the center of the base part toward the primary coil and inserted into the first hollow part of the primary coil; and
a pair of outer legs protruding from the outer side of the base part toward the primary coil and spaced apart from the center leg,
wherein the second magnetic core includes:
a flat base part;
a center leg protruding from the center of the base part toward the secondary coil and inserted into the second hollow part of the secondary coil; and
a pair of outer legs protruding from the outer side of the base part toward the secondary coil and spaced apart from the center leg,
wherein the first mount includes:
a thin plate-shaped first plate having a first central hole formed at the center thereof;
a cylindrical first support tube having a first through hole formed to communicate with the first central hole of the first plate to be inserted into the first hollow part of the primary coil, and holding the primary coil by protruding from the first central hole toward the primary coil;
a first front wing protruding from the front edge of the first plate toward the first magnetic core, and being in close contact with the front surface and the outer legs of the first base part of the first magnetic core to prevent movement or displacement of the first mount; and
a first rear wing protruding from the rear edge of the first plate toward the first magnetic core, and being in close contact with the rear surface and the outer legs of the first base part to prevent movement or displacement of the first mount,
wherein the second mount includes:
a circular plate-shaped second disk having a second central hole;
a cylindrical second lower support tube having a second lower through hole formed to communicate with the second central hole of the second disk to be inserted into the first hollow part of the primary coil, and protruding from the second central hole toward the primary coil to be partially mounted with the first support tube of the first mount and hold the upper side of the primary coil; and
a cylindrical second upper support tube having a second upper through hole formed to communicate with the second central hole of the second disk to be inserted into the second hollow part of the secondary coil, and protruding from the second central hole toward the secondary coil to be partially mounted with a third support tube of the third mount and hold the lower side of the secondary coil,
wherein the third mount includes:
a thin plate-shaped third plate having a third central hole;
a cylindrical third support tube having a third through hole formed to communicate with the third central hole of the third plate to be inserted into the second hollow part of the secondary coil, and protruding from the third central hole toward the secondary coil to be partially mounted with the second upper support tube of the second mount and hold the upper side of the secondary coil;
a third front wing protruding from the front edge of the third plate toward the second magnetic core, and being in close contact with a front surface of the second base part of the second magnetic core at the same time to prevent movement or displacement of the third mount; and
a third rear wing protruding from the rear edge of the third plate toward the second magnetic core, and being in close contact with a rear surface and the outer legs of the second base part of the second magnetic core to prevent movement or displacement of the third mount,
wherein the primary coil is mounted on the first plate and inserted between the first plate and the second disk in the height direction, and externally fits and fixes the first hollow part to the first support tube and the second lower support tube in the radial direction,
wherein the secondary coil is mounted on the second disk and inserted between the second disk and the third plate in the height direction, and externally fits and fixes the second hollow part to the third support tube and the second upper support tube in the radial direction,
wherein the first magnetic core is located below the first mount, and is inserted into the first hollow part of the primary coil by being inserted into the first support tube and the second lower support tube in which the center leg is axially mounted, and
wherein the second magnetic core is located above the second mount, and is inserted into the second hollow part of the secondary coil by being inserted into the third support tube and the second upper support tube in which the center leg is axially mounted.

5. The transformer for an on-board charger of an electric vehicle according to claim 4, wherein the first plate of the first mount has a circular plate shape that matches the primary coil,
wherein the third plate of the third mount has a circular plate shape that matches the secondary coil, and
wherein the second disk of the second mount has a circular disk shape that matches the primary and secondary coils.

6. The transformer for an on-board charger of an electric vehicle according to claim 5, wherein the first front wing of the first mount includes:
a first front wing central part protruding from the front edge of the first plate toward the first magnetic core to be in close contact with the center of the front surface of the base part of the first magnetic core; and
a first front wing bent part extending from the first front wing central part to be bilaterally symmetrical and being in close contact with the outer edges of the front surface of the base part and the outer legs of the first magnetic core,
wherein the first rear wing of the first mount includes:
a first rear wing central part protruding from the rear edge of the first plate toward the first magnetic core to be in close contact with the center of the rear surface of the base part of the first magnetic core; and
a first rear wing bent part extending from the first rear wing central part to be bilaterally symmetrical and being in close contact with the outer edges of the rear surface of the base part and the outer legs of the first magnetic core,
wherein the outer surface of the outer leg of the first magnetic core includes:
a horizontal plane formed at the center thereof; and
a pair of inclined planes symmetrically sloping inward toward the center leg from the horizontal central plane,
wherein the first front wing bent part is concavely bent inward to be in close contact with the front surface of the base part and the inclined planes of the outer legs of the first magnetic core at the same time,
wherein the first rear wing bent part is concavely bent inward to be in close contact with the rear surface of the base part and the inclined planes of the outer legs of the first magnetic core at the same time,
wherein the third front wing of the third mount includes:
a third front wing central part protruding from the front edge of the third plate toward the second magnetic core to be in close contact with the center of the front surface of the base part of the second magnetic core; and
a third front wing bent part extending from the third front wing central part to be bilaterally symmetrical and being in close contact with the outer edges of the front surface of the base part and the outer legs of the second magnetic core,
wherein the third rear wing of the third mount includes:
a third rear wing central part protruding from the rear edge of the third plate toward the second magnetic core to be in close contact with the center of the rear surface of the base part of the second magnetic core; and
a third rear wing bent part extending from the second rear wing central part to be bilaterally symmetrical and being in close contact with the outer edges of the rear surface of the base part and the outer legs of the second magnetic core,
wherein the outer surface of the outer leg of the second magnetic core includes:
a horizontal plane formed at the center thereof; and
a pair of inclined planes symmetrically sloping inward toward the center leg from the horizontal central plane,
wherein the third front wing bent part is concavely bent inward to be in close contact with the front surface of the base part and the inclined planes of the outer legs of the second magnetic core at the same time, and
wherein the third rear wing bent part is concavely bent inward to be in close contact with the rear surface of the base part and the inclined planes of the outer legs of the second magnetic core at the same time.

7. The transformer for an on-board charger of an electric vehicle according to claim 4, wherein a lower step flange is formed on the outer peripheral surface of the second lower support tube,
wherein an upper step flange is formed on the outer peripheral surface of the second upper support tube,
wherein the lower step flange of the second lower support tube is step-supported on the top of the first support tube, allowing the first support tube and the second lower support tube to overlap axially,
wherein in the state where the first support tube and the second lower support tube overlap axially, the outer peripheral surfaces of the first support tube and the second lower support tube form the same surface,
wherein the bottom of the third support tube is step-supported on the upper step flange of the second upper support tube, allowing the second upper support tube and the third support tube to overlap axially, and
wherein in the state where the second upper support tube and the third support tube overlap axially, the outer peripheral surfaces of the second upper support tube and the third support tube form the same surface.

8. The transformer for an on-board charger of an electric vehicle according to claim 4, wherein a plurality of second lower fitting grooves are formed on the outer circumference of the second lower support tube at regular intervals,
wherein first fitting protrusions which fit into the second lower fitting grooves are formed on the inner circumference of the first support tube of the first mount,
wherein a plurality of second upper fitting grooves are formed on the outer circumference of the second upper support tube at regular intervals, and
wherein third fitting protrusions which fit into the second upper fitting grooves are formed on the inner circumference of the third support tube of the third mount.

9. The transformer for an on-board charger of an electric vehicle according to claim 4, wherein a boss protrudes rearward from the rear surface of the second disk and has a rear surface of a flat plane,
wherein the rear surface of the first rear wing is a flat plane,
wherein the rear surface of the third rear wing is a flat plane, and
wherein the rear surface of the boss, the rear surface of the first rear wing, and the rear surface of the third rear wing are all positioned on the same vertical plane.
